(19) United States
(12) Patent Application Publication
(10) Pub. No.: US 2001/0048469 A1
(43) Pub. Date: Dec. 6, 2001

(54) METHOD AND APPARATUS FOR ILLUMINATING DOWNWARDLY EXTENDING FEATURES ON ELECTRONIC COMPONENTS OR MECHANICAL DEVICES

(76) Inventor: GEORGE D. ECK, BINGHAMTON, NY (US)

Correspondence Address: UNIVERSAL INSTRUMENTS CORPORATION, ATTN: CHRISTINA JOHNSON, ESQ., PO BOX 825, BINGHAMTON, NY, 13902, US

(21) Appl. No.: 09/044,049

(22) Filed: Mar. 18, 1998

(51) Int. Cl. H04N 7/18; H04N 9/47

(52) U.S. Cl. 348/126

(57) ABSTRACT

A method and apparatus for illuminating the end portions of downwardly extending features of a component without substantially illuminating the body of the component. At least one light source is configured to direct a fan-shaped sheet of light at the downwardly extending features of the component at a low angle of incidence with respect to the component body. A camera or other image capture device captures an image of the illuminate downwardly extending features and signal processing means determine the position of the downwardly extending features from the image thus formed with respect to a desired position.

### FIELD OF THE INVENTION

The present invention relates to a method and apparatus for illuminating downwardly extending features on electronic components or mechanical devices. More particularly, the present invention relates to illuminating an end portion of the downwardly extending features without substantially illuminating the body of the component or mechanical device.

### BACKGROUND OF INVENTION

In the construction of modern products, automatic assembly, including automatic placement and mounting of electronic components and mechanical devices, has become increasingly popular. However, in recent years, components have become smaller, the average number of leads has increased and the use of non-standard components has increased. Consequently, the use of such automated assembly procedures has become more difficult due to the uncertainty involved in determining the position of the leads or mounting tabs prior to placement. Many modern assembly machines, therefore, include a vision system for determining the exact location of the leads on individual components.

One type of vision system used in assembly machines utilizes a shade disposed between a light source and the component to illuminate the leads while substantially shading the body of the component. A camera is positioned under the component to obtain an image of the illuminate leads, which is then used to calculate their actual location. Because the shade is positioned between the camera and component, the field of view of the camera is limited by the shade.

Another type of vision system utilizes two laser beams projected in different directions within a component travel path. The component is moved in a straight-line through the travel path such that the laser beams are sequentially interrupted by the leads of the component. Light sensitive transistors detect when the beams are broken by the leads and the location of the leads is then calculated using a series of complex mathematical equations. When detecting multiple lead configurations, it is important that no lead be obstructed by the other leads because this could produce ambiguous results. Thus, particular care must be taken in selecting the angle between the laser beams for each component to be detected. This results in a reduced flexibility of the system.

### SUMMARY OF THE INVENTION

It is, therefore, an object of the present invention to provide a method and apparatus for illuminating the leads of a component.

It is a further object of the present invention to illuminate the leads of a component without illuminating the body of the component.

It is another object of the present invention to illuminate the leads of a component without illuminating the body of the component and without the use of a shade.

It is yet another object of the present invention to determine the location of the leads of a component to be placed by an automated assembly machine.

The above and other objects are achieved in accordance with the present invention by a method and an apparatus for illuminating an end portion of the leads or other downwardly extending features of a component or mechanical device. One or more light sources 40 project sheets of light at the leads of a component from different angles. Each sheet of light is projected at a low angle of incidence with respect to the body of the component. An image capture device is positioned below the component so as to form an image of the leads. The image capture device is coupled to a computer, which determines from the image the position of the leads within the field of view of the image capture device with respect to a desired position.

These and other objects, features and advantages of the present invention will be apparent and fully understood from the following detailed description of the preferred embodiments, taken in connection with the appended drawings. While the present invention is described herein in the context of a vision system of a component placement apparatus and components having leads, it should be understood throughout to apply equally to any vision system and the illumination of any downwardly projecting feature, including pins, tabs and solder bumps, of any component or mechanical device.

### BRIEF DESCRIPTION OF THE DRAWINGS

FIG. 1 is a plan view of an illumination system according to the present invention.

FIG. 2 is a side elevational view of the illumination system of FIG. 1.

FIG. 3 is a side elevational view of a light source from the illuminating system of FIG. 1.

FIG. 4 is a rear elevational view of the light source of FIG. 3.

FIG. 5 is a plan view of the light source of FIG. 3.

FIG. 6 is a plan view of the lens mount from the light source of FIG. 3.

FIG. 7 is a side elevational view of the lens mount of FIG. 6.

FIG. 8 is a front elevational view of the lens mount of FIG. 6.

FIG. 9 is a side elevational view of an alternate illumination system according to the present invention.

### DETAILED DESCRIPTION OF THE PREFERRED EMBODIMENT

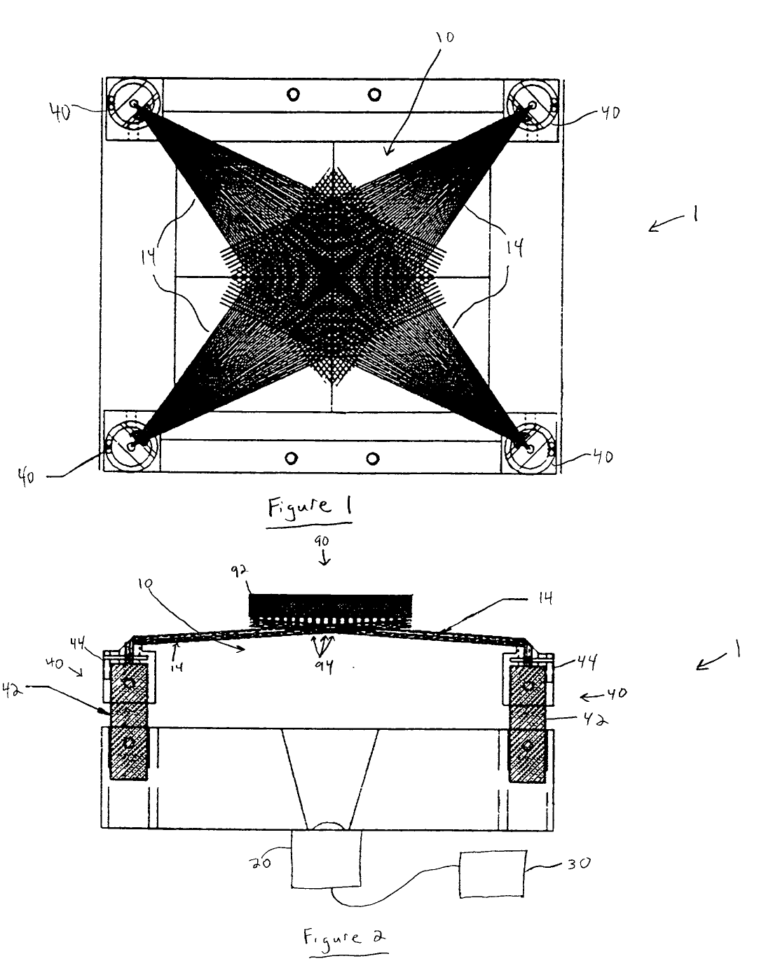

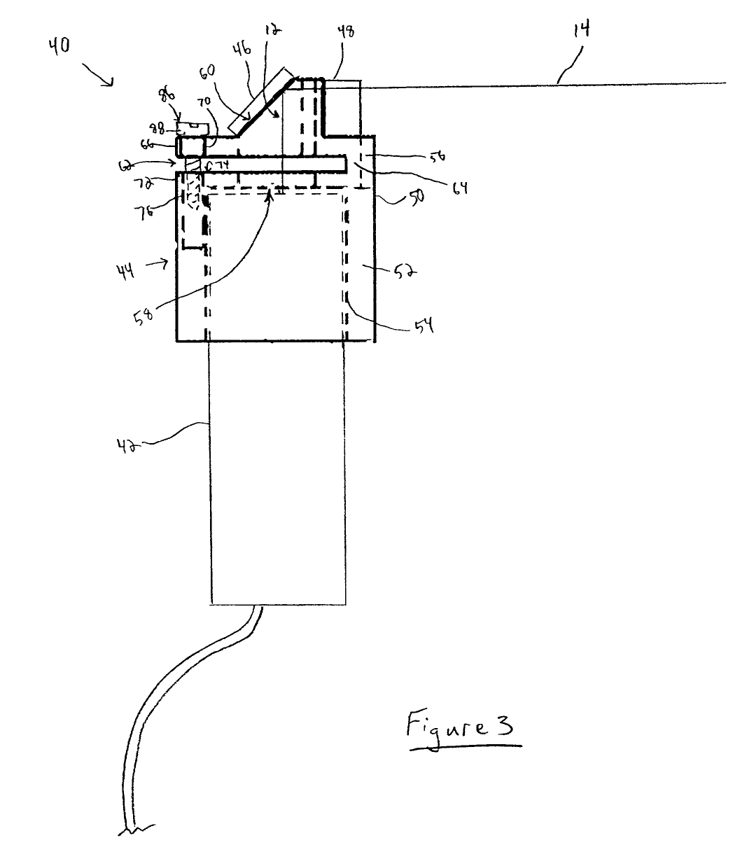

Referring first to FIGS. 1 and 2, an illumination system 1 according to the present invention is illustrated. The system 1 includes four light sources 40 positioned in the four corners of an imaging area 10. The light sources 40 each produce a fan-shaped planar sheet of light 14 and direct it towards the center of the imaging area 10. A CCD camera 20 is mounted at the center of the light sources 40 and is aimed up into the imaging area 10 where the fan-shaped sheets of light 14 intersect. It should be noted that FIG. 2 may be “flipped” and the camera 20 may be mounted above the imaging area 10 and aimed downward.

As best seen in FIGS. 2 and 3, each sheet of light 14 is relatively thin in the vertical direction. For example, in the illustrated embodiment the sheets 14 are approximately 60-80/1000 of an inch thick. Using this arrangement, the sheets 14 may be precisely aimed in the horizontal plane. Thus, the leads 94 of a component 90 held in the imaging area 10 (e.g., by the pick and placement head of an assembly machine) can be illuminated by the light sources 40 without substantially illuminating the body 92 of the component 90.

While a symmetric arrangement of the light sources 40 around the camera 20 provides the greatest flexibility, it should be noted that other arrangements may be utilized depending, in part, on the component 90 being imaged. In addition, fewer or more light sources 40 may be used so long as they are sufficient in number and positioned so as to illuminate all of the desired leads 94 of the components 90 to be placed without substantially illuminating the bodies 92. For example, if the components 90 in question have only three or four well spaced leads 94, one light source 40 may be sufficient. However, as the number of component leads 94 increases and/or becomes more dense, the number of light sources 40 used will likely increase to ensure that all of the desired leads 94 are illuminated. Likewise, the reflective characteristics of the leads 94 also affect the required number and arrangement of the light sources 40.

Referring now to FIGS. 3-5, each light source 40 includes a laser module 42 and a dispersion assembly 44. The laser module 42 of the illustrated embodiment is a model LMG6354A5-T distributed by Lasermate Corporation of Monterey Park, Calif. This is a Class IIIa laser diode module which emits a laser beam 12 having a wavelength of 635 nm, a maximum output power of 5 mW and a beam width of approximately 60-80/1000 of an inch. In addition, the laser beam 12 may be pulsed by a control line of the laser module 42.

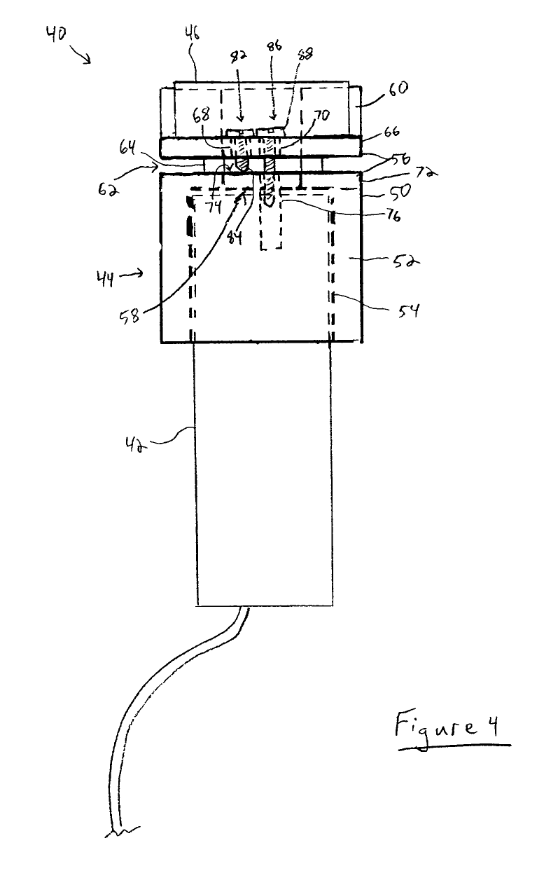

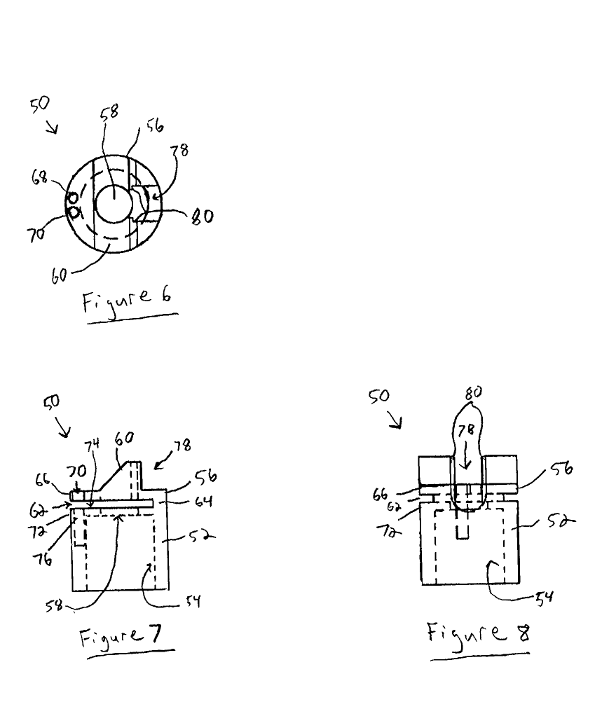

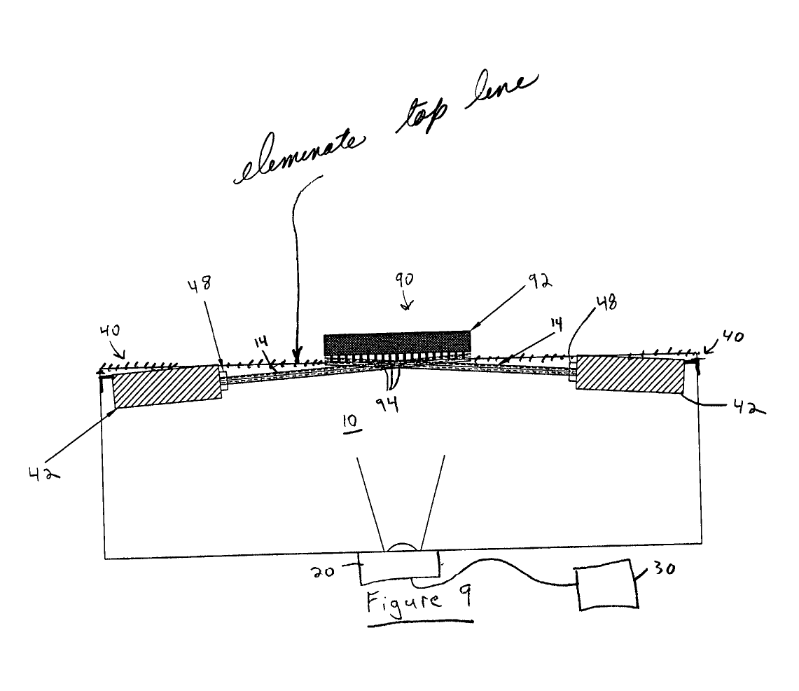

As indicated, each light source 40 also includes a dispersion assembly 44 mounted to the laser module 42. The dispersion assembly 44 includes an aluminum lens mount 50, shown in detail in FIGS. 6-8. The lens mount 50 has a cylindrical body 52 having an interior chamber 54 adapted for mounting to the laser 42 (see FIGS. 3 and 4). A bore 58 extends axially through the head 56 of the body 52 to permit projection of the laser beam 12 therethrough.

The top of the head 56 adjacent the bore 58 has an inclined top surface 60. This surface 60 permits mounting of a mirror 46 (shown in FIGS. 3-5) in line with the laser beam 12 to facilitate aiming of the beam 12, as described below. The inclined surface 60, and hence the mirror 46 of the illustrated embodiment is oriented at 45° with respect to the horizontal and thereby directs the laser beam 12 out the front of the lens mount 50. This orientation is selected because the laser modules 42 of the illustrated embodiment are aimed approximately vertically when mounted around the imaging area 10. Thus, after being reflected by the mirror 46, the beams 12 of the lasers are directed out the front of the lens mount 50 approximately parallel with the horizontal. The beams 12 may then be adjusted to project at very small angles with respect to the horizontal and, consequently, at very small angles with respect to the component body 92.

The adjustment of the laser beam 12 is facilitated through an adjustment groove 62 and two adjustment screws 82, 86 in the lens mount 50. The groove 62 is cut transversely through the head 56 of the lens mount 50 thereby dividing it into a top portion 66 and a bottom portion 72. The groove 62 extends from the back of the lens mount 50 towards the front, leaving only a small connecting section 64 between the top portion 66 and bottom portion 72 of the head 56 at the front of the lens mount 50.

The top portion 66 of the head 56 has two holes 68, 70 adjacent one another at the back end for receiving the adjustment screws 82, 86. The first hole 68 is threaded and the second one 70 is not. The bottom portion 72 of the head 56 includes one threaded hole 76 aligned with the non-threaded hole 70 of the top portion 66 of the head 56. The first adjustment screw, the jacking screw 82, is screwed into the threaded hole 68 of the top portion 66 and the tip 84 of the screw 82 abuts the top surface 74 of the bottom portion 72. The second adjustment screw, the locking screw 86, is inserted through the non-threaded hole 70 of the top portion 66 and is screwed into the threaded hole 76 of the bottom portion 72.

When the jacking screw 82 is turned clockwise, the tip 84 pushes against the top surface 74 of the bottom portion 72 of the head 56 and thereby urges the top portion 66 of the head 56 away from the bottom portion 72 at the rear. This decreases the angle of the mirror 46 with respect to the horizontal and lowers the laser beam 12 towards the horizontal. Turning the jacking screw 82 in the opposite direction withdraws the tip 84 from the top surface 74 of the bottom portion 72 and leaves the top portion 66 free to be drawn closer to the bottom portion 72. This increases the angle of the mirror 46, and consequently the laser, with respect to the horizontal.

When the locking screw 86 is turned clockwise, the head 88 of the screw 86 pulls the top portion 66 of the head 56 towards the bottom portion 72 at the rear and locks the top portion 66 in position with the tip 84 of the jacking screw 82 against the top surface 74 of the bottom portion 72. Thus, the angle of the laser beam 12 may be adjusted and locked by turning the adjustment screws 82, 86 to achieve a stable alignment of the beam 12 at a desired angle. It should be noted that other aiming schemes may be employed. For example, the angular relationship of the mirror 46 to the laser beam 12 may be fixed and adjustment may be facilitated by adjusting the mounting orientation of the entire light source 40. Likewise, the mirror 46 may be mounted at a fixed angular relation to the imaging area 10 and the angle of the laser beam 12 adjusted.

As described, the laser beam 12 is reflected by the mirror 46 towards the front of the lens mount 50. The lens mount 50, therefore, includes a lens aperture 78 at the front to permit the projection of the beam 12 out of the mount 50. The lens aperture 78 has a ledge 80 on each side for the mounting of a convex dispersing lens 48. The lens 48 is mounted to the ledge 80 by an adhesive, such as ultraviolet glue.

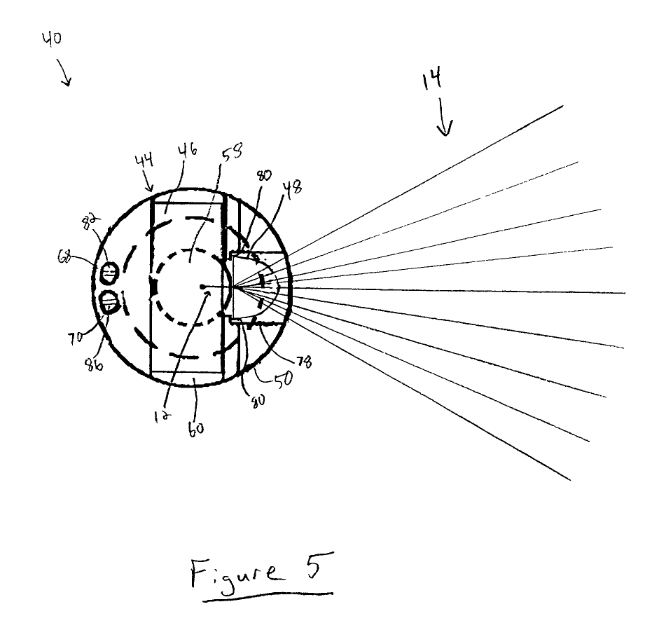

The lens 48 of the illustrated embodiment is an LGLI-45 line generating lens (or “cylinder lens”) commercially available from Rolyn Optics, Covina, Calif. The lens 48 is made of an acrylic and is designed to disperse the collimated laser beam 12 in the horizontal direction only into a fan-shaped, planer sheet of light 14. Thus, the light emitted from the light source 40 remains approximately the same dimension in the vertical direction (see FIG. 3) while at the same time it is fanned out in the horizontal direction (see FIG. 5). In the illustrated embodiment, the sheet of light 14 emitted by the light source 40 is approximately 60-80/1000 of an inch thick in the vertical direction and has a 30° spread angle. Other beam dimensions and shapes may be employed and depend on various factors such as the number of light sources 40 used, laser power, component size, lead count and density and distance to the leads 94.

Because of the unique shape of the sheet of light 14 emitted by the light source 40, it can be aimed very precisely in the horizontal plane. It can, therefore, be aimed to strike multiple leads 94 across a component 90 without substantially illuminating the body 92 of the component 90. To properly adjust the angle of the sheet of light 14, the adjustment screws 82, 86 are adjusted such that the sheet of light 14 strikes the leads 94 closest to the light source 40 while at the same time not striking the body 92 of the component 90 at the point furthest from the light source 40 (see FIG. 2). This is made possible by the use of a small angle with respect to the horizontal and, consequently, a small angle of incidence with respect to the component body 92.

Referring to FIG. 3, it can be seen that by aiming the laser beam 12 at the top portion of the mirror 46, the sheet 14 may be projected at a very slight angle above the horizontal and still rise to a level above the top of the light source 40 in a relatively short distance. This allows for the use of a very small angle of incidence with respect to the component body 92, thereby, facilitating the illumination of leads 94 on wider components 90. Projecting the laser at the top of the mirror 46 also allows the leads 94 of the component 90 to be illuminated without being lowered below the top of the light source 40. Thus, the component 90 can be passed over the illumination area 10 on its way to being placed without stopping to lower it vertically into the imaging area 10. By pulsing the light sources 40 at the appropriate time, the CCD camera 20 can capture the image of the leads 94 as the component 90 passes over the imaging area 10. Alternatively, the camera 20 can include an electronic shutter to be selectively activated in which case the light sources 40 would not need to be pulsed.

Once the image of the illuminated leads 94 has been captured by the camera 20, a computer processor 30 is used to calculate and record the location of the leads 94 within the field of view of the camera 20. These values are then compared with expected or desired locations for the leads 94. If location of the leads 94 of the component 90 being placed deviate from these expected values, the placement apparatus can either reflect the component or adjust dynamically to compensate for the difference and ensure proper placement of the component 90.

The present invention has been described in terms of illustrated embodiments thereof. Other embodiments, features and variations within the scope of the appended claims will, given the benefit of this disclosure, occur to those having ordinary skill in the art. For example, the laser modules 42 may be aimed approximately horizontal, as illustrated in FIG. 9. In such a case, the dispersion lenses 48 are mounted directly in front of the laser modules 42 and the mirrors may be omitted. Aiming of the resulting sheets of light can be facilitated by moving the laser modules 42 and/or the lenses 48.

What is claimed is:

1. A method of illuminating an end portion of at least one downwardly extending feature of a component comprising the steps of:
illuminating the end portion of said at least one downwardly extending feature using at least one sheet of light directed at a low angle of incidence with respect to a body portion of the component.;
positioning an image capture device that has a field of view such that the image of said end portion is within the field of view; and
determining the position of said at least one downwardly extending feature within the field of view of the image capture device with respect to a desired position.

2. The method of illuminating of claim 1 wherein said step of illuminating said end portion comprises projecting a collimated beam of light through a convex lens so as to form a sheet of light.

3. An apparatus for illuminating an end portion of at least one downwardly extending feature of a component comprising:
a first light source for providing a first sheet of light;
an image capture device having a field of view, the image capture device being configured to form an image of said end portion; and
signal processing means for determining from said image the position of said end portion within the field of view of the image capture device with respect to a desired position.

4. The apparatus of claim 3 wherein said first light source comprises:
a first collimated light beam source producing a first collimated light beam; and
a first convex lens disposed in relation to said first collimated light beam source so as to produce a first fan-shaped sheet of light.

5. The apparatus of claim 4 wherein said first light source further comprises a mirror disposed so as to direct said first sheet of light toward said end portion at a relatively low angle of incidence with respect to a body portion of the component.

6. The apparatus of claim 5 further comprising means for adjusting the angle of incidence with respect to the body portion of the component.

7. The apparatus of claim 6 wherein said means for adjusting the angle of incidence includes means for adjusting the angle of the mirror with respect to the first collimated light beam source.

8. The apparatus of claim 3 further comprising:
an imaging area disposed proximate said first light source; and
at least a second light source disposed proximate said imaging area for providing at least a second sheet of light.

9. An apparatus for illuminating an end portion of at least one downwardly extending feature of a component having a body comprising:
a light source producing a light;
means for dispersing said light so as to illuminate said end portion without substantially illuminating the component body;
an image capture means having a field of view disposed to form an image of the end portion; and
signal processing means for determining the position of the end portion within said field of view of the image capture means with respect to a desired location.
